(19) United States
(12) Patent Application Publication
(10) Pub. No.: US 2019/0212151 A1
(43) Pub. Date: Jul. 11, 2019

(54) FACILITY NAVIGATION

(71) Applicants: LYNETTE PARKER, Jacksonville, FL (US); RONNIE WESTON, Jacksonville, FL (US)

(72) Inventors: LYNETTE PARKER, Jacksonville, FL (US); RONNIE WESTON, Jacksonville, FL (US)

(21) Appl. No.: 15/863,577

(22) Filed: Jan. 5, 2018

(51) Int. Cl. G01C 21/20; H04W 4/30; G06T 19/00; G06F 3/16; G06F 3/048

(52) U.S. Cl. CPC G01C 21/206; H04W 4/30; G06F 9/445; G06F 3/167; G06F 3/048; G06T 19/003

(57) ABSTRACT

A computer assisted system for providing navigational assistance to a user towards a desired destination associated with a facility includes an electronic communication device running an application providing an indoor and outdoor location information associated with the facility and a real-time, dynamic, interactive navigational assistance information to the desired destination, a number of three-dimensional indoor positioning devices installed at the facility for identifying a real-time location of the electronic communication devices and a server in communication with the electronic communication devices over a wireless communication channel for storing the indoor and outdoor location information associated with the facility. An interactive dynamic graphical user interface of the application provides step-by-step instructions in form of augmented reality based real-time visuals and audio instructions towards the desired destination selected by the user based on the real-time location of the electronic communication device identified using the three-dimensional indoor positioning devices at the facility.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

### Field of the Invention

The present invention relates generally to methods and systems for receiving navigation instructions associated with a facility. More specifically, the present invention relates to a system and method for receiving navigation instructions to a desired destination within a facility.

### Background of the Invention

Portable electronic devices, such as, smartphones, smart wearable devices, laptops, personal digital assistants, tablets, and the like, are fast becoming prevalent in everyday life. One of the services that have increased the desirability of these devices is the navigation guidance service that provides navigation guidance to an end user. Typically, these devices are equipped with one or more sensors for providing navigation guidance to the end user. For example, a portable communication device, such as a smartphone may include, inertial or motion sensors e.g., accelerometers, gyroscopes, compasses, etc. capable of measuring locations, or orientations of the device, or Global Positioning System (GPS) receivers that may estimate geographic location of the device and then provide navigation guidance to a user based on the location. One of the main issues with these sensor based navigation guidance is the dependence on the measurement accuracy of the sensors. For example, the navigation guidance may be dependent on the accuracy of mobile device orientation measured by a compass sensor. Additionally, the quality of sensor based navigation guidance may also vary in different environments. For example, the quality of GPS sensor based navigation guidance may be low in an indoor environment, due to the low signal strength. In some other existing wireless geolocation services, accessible from the mobile devices such as smartphones and portable navigation devices, the location tracking rely exclusively on a combination of global positioning service (GPS) geolocation technology and cell tower triangulation to provide a real-time position information for the user. Although popular and widely utilized, the technological basis of these services limits their applications to outdoor activities.

While the outdoor navigation space may be served by the GPS and cellular triangulation technologies, indoor geolocation/navigation space is far more challenging. Some systems rely on user-installed short-range Bluetooth beacons to populate the indoor landscape thus providing a network of known fixed emitters for wireless devices to reference. Other systems rely on costly user-installed intelligent Wi-Fi access points to assist wireless devices with indoor navigation requirements. Both of these “closed system” approaches seek to overcome the inherent difficulties of accurately receiving, analyzing, and computing useful navigation data in classic indoor RF environments by creating an artificial “bubble” where both emitters and receivers are controlled. These “closed” systems require large investments of resources when implemented at scale. While end-users are conditioned to expect wireless geolocation technologies to be ubiquitous and consistent, the closed systems typically are unable to satisfy this need.

Further, determining the location and the path to a location in a complex environment, such as a department of patient room in a large hospital or student or faculty room in a university is another problem for which many alternative solutions exist. The three most common solutions involve the use of printed maps, direction signs, and verbally asking for directions. In the case of maps, a user has to find his desired destination on the map, his or her current position, and “compute” the path to the destination. Further, the user has to navigate the real environment using the path found on the map system. Many people experience difficulties when attempting to transform a path represented on a map to a path in the real environment.

In the case of static direction signs positioned on walls or ceilings, the size of the physical signs puts a limit on the number of sites to which the signs can be point. Verbally asking for directions involves finding another person knowledgeable about the environment, understanding and memorizing the verbal instructions, and following the path. Many people are uncomfortable about asking for directions, and interpreting and memorizing verbal instructions is difficult and often prone to mistakes.

Modern indoor navigation systems are proposed to use interactive direction systems with the help of smartphones or similar portable electronic devices. A number of different types of applications and devices are disclosed in the prior arts, some of which are herein incorporated by reference for their supportive teachings, and are as follows:

U.S. Pat. No. 8,320,939 B1 titled “Crowd-sourced information for interior localization and navigation” issued to Google Inc. shows a system and method of using crowd sourced information to generate walkable paths through indoor spaces. More specifically, the patent relate to recording data such as accelerometer readings, wireless network or other beacon signal information, and timestamps while a client device moves within an indoor space. If the user reaches a destination within the indoor space, the client device may prompt the user for information about the destination. The information received and recorded by the client device may be sent to a server computer for further processing. The server may use the information to identify walkable paths within the indoor space. This information in turn may be used in various ways, such as to provide navigation assistance to users though the indoor space.

U.S. Patent Application No. 20150160018 A1 titled “Sensor-less indoor navigation assistance” filed by Michael Ameling et al. discloses systems and methods for providing navigation assistance inside a building structure. A navigation assistance request is received for commuting between the start waypoint and the destination waypoint. Based on the received request, the angle-orientation coordinates included in the angle-based navigation instruction are converted to direction-based navigation instructions. Finally, the direction-based navigation instructions are provided to a user. In one embodiment, the direction-based navigation instructions are stored in a directed weighted graph. The directed weighted graph may be used to determine navigation instructions for an intersection point. In one embodiment, crowdsourcing is used to collect the navigation instructions.

U.S. Pat. No. 8,866,673 B2 titled “System and method for providing indoor navigation and special local base service application for malls stores shopping centers and buildings utilize RF beacons” issued to Ehud Mendelson relates to a system and method that could guide people around urban environments indoor and outdoor such as in a facility area like a mall, department store etc. The system provides a direct content according to the user preference and profile and navigation guidance to the user via an application in communication with the application for benefitting services from the mall store or building facility area. The content and navigation are displayed on the existing cellular phone as mobile application.

However, none of the above inventions and patents, taken either singly or in combination, is seen to disclose an invention with an object to provide with an improved system and method in a smartphone or a smart wearable device or any smart device enabled to detect directions towards a desired destination inside a building structure. Hence, there exists a need for an improved system, which provides efficient automated and real-time navigation guidance to a desired destination inside a building structure.

### SUMMARY OF THE INVENTION

The present invention relates to a computer assisted system for providing navigational assistance to a user towards a desired destination associated with a facility. The present computer assisted system includes an electronic communication device having a processor configured to execute a number of instructions of an application for providing a variety of services including an indoor and outdoor location information associated with the facility and a real-time, dynamic, interactive navigational assistance information to the desired destination associated with the facility. The computer assisted system further includes one or more three-dimensional indoor positioning devices, capable of communicating with the electronic communication devices, installed at a number of locations associated with the facility for identifying a real-time location of the electronic communication devices and a server in communication with the electronic communication devices for storing the indoor and outdoor location information associated with the facility and a wireless communication channel to enable communication between the electronic communication devices and the servers to provide the real-time, dynamic, interactive navigational assistance information to the desired destinations selected by the users. The application running on the electronic communication devices allow the users to navigate towards the desired destination interior or exterior to the facility by following the real-time, dynamic, interactive navigational assistance information presented through an interactive dynamic graphical user interface of the application.

The present invention further relates to a computer assisted method for providing navigational assistance to a user towards a desired destination associated with a facility. The method includes the steps of providing an electronic communication device running an application for presenting a variety of services including an indoor and outdoor location information associated with the facility and a real-time, dynamic, interactive navigational assistance information to the desired destination associated with the facility. The method further includes the steps of launching the application from the electronic communication device to enable connection with the three-dimensional indoor positioning devices installed at the facility, receiving the facility related information, upon connection with the three-dimensional indoor positioning devices, through the application for easy navigation inside the facility, selecting the desired destination associated with the facility from the interactive dynamic graphical user interface of the application running on the electronic communication device and receiving the real-time, dynamic, interactive navigational assistance information towards the desired destination based on a real-time location of the electronic communication devices identified using the three-dimensional indoor positioning devices installed at the facility. The real-time, dynamic, interactive navigational assistance information received through the interactive dynamic graphical user interface of the application allows the users to easily navigate to the desired destination interior or exterior to the facility.

The present invention further relates to an electronic communication device for providing real-time, dynamic, interactive navigational assistance information towards a desired destination associated with a facility. The electronic communication device includes a processor configured to execute a number of instructions of an application, retrievably stored in a memory unit in communication with the processor, for providing a variety of services including an indoor and outdoor location information associated with the facility and a real-time, dynamic, interactive navigational assistance information to the desired destination associated with the facility. The electronic communication device also includes a wireless communication unit to communicate with a server over a wireless communication channel for receiving the indoor and outdoor location information for easy navigation inside the facility, one or more sensors for communicating with a number of three-dimensional indoor positioning devices installed at the facility to identify a real-time location of the electronic communication device, a display unit configured to display an interactive dynamic graphical user interface of the application for visually presenting the plurality of real-time, dynamic, interactive navigational assistance information towards the desired destinations selected by the users and an audio unit for audible presentation of the real-time, dynamic, interactive navigational assistance information to the desired destinations selected by the users. The real-time, dynamic, interactive navigational assistance information presented through the interactive dynamic graphical user interface of the application displayed on the display unit is continuously updated, in real-time, based on the real-time location of the electronic communication device. The interactive dynamic graphical user interface of the application displayed on the display unit allows the users to interact with the plurality of indoor and outdoor location information and the real-time, dynamic, interactive navigational assistance information for easy navigation inside the facility.

The primary feature of the present invention presents a system for providing navigational assistance to a user towards a desired destination associated with a facility.

Another feature of the present invention presents a system having an electronic communication device running an application for providing navigational assistance to a user towards a desired destination inside or exterior to a facility.

Another feature of the present invention presents a system having a number of three-dimensional indoor positioning devices installed at a facility to identify a real-time location of the electronic communication device of the users for providing navigational assistance to the user towards a desired destination associated with the facility.

Yet another feature of the present invention presents a system having an electronic communication device running an application for providing navigational assistance to a user towards a desired destination inside or exterior to a facility based on a floor layout received from the facility.

Yet another feature of the present invention presents a system having an electronic communication device running an application configured to allow the users to upload a variety of facility related information to a server to form a crowd sourced data source for assisting in easy navigation of the users inside the facility.

Another feature of the present invention presents a system having an electronic communication device running an application for providing step-by-step instructions towards a desired destination inside a facility.

Another feature of the present invention presents a method for identifying a real-time location of an electronic communication device of a user inside a facility for providing navigational assistance to a desired destination within the facility.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness. The invention will be described and explained with additional specificity and detail through the use of the accompanying drawing in which:

FIG. 1 is a schematic view of a computer assisted system for providing navigational assistance to a user towards a desired destination associated with a facility, according to a preferred embodiment of the present invention;

FIG. 2 illustrates the schematic diagram showing a number of three-dimensional indoor positioning devices installed at a high rise building facility for identifying real-time locations of a number of electronic communication devices of a number of users inside the facility, according to an embodiment of the present invention;

FIG. 3 illustrates the schematic diagram showing a number of three-dimensional indoor positioning devices installed at a floor of a facility for providing navigational assistance to the users towards the desired destination in the floor, according to an embodiment of the present invention;

FIG. 4 illustrates a block diagram showing the different components of the electronic communication device installed with an application for providing navigational assistance to the users towards the desired destination associated with the facility and capable of communicating with the three-dimensional indoor positioning devices installed at the facility, according to an embodiment of the present disclosure;

FIG. 5 illustrates a block diagram showing the different components of a server in communication with the electronic communication devices installed with the application for providing navigational assistance to the users inside a facility, according to an embodiment of the present disclosure;

FIG. 6 illustrates a block diagram showing the different components of the computer devices associated with the facilities, according to an embodiment of the present invention;

FIG. 7 is a flowchart showing a number of steps for receiving navigational assistance towards a desired destination associated with a facility, according to an embodiment of the present disclosure;

FIG. 8 shows a user interface of the application running on the electronic communication device of the user for providing navigational assistance to the users towards the desired destination associated with a facility, according to an embodiment of the present disclosure; and

FIG. 9 shows a user interface of the application running on the electronic communication device of the user for providing navigational assistance to the users towards the desired destination associated with a facility, according to an alternate embodiment of the present disclosure.

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention. The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

Further, various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The following embodiments and the accompanying drawings, which are incorporated into and form part of this disclosure, illustrate one or more embodiment of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

The present invention can be implemented on any communication device that has hardware components that can perform wireless and wired communication, such as, but not limited to, laptop computer, multi-purpose pocket computers, cellular telephones, personal multimedia devices, smart electronic devices, smart wearable devices etc. and using the standard operations thereof in similar fashion. The various devices on which the applications that implement the present invention run may use one or more processors with different instruction-sets, architectures, clock-speeds, etc. and memory that may include high speed random access memory and may include non-volatile memory, such as one or more magnetic disk storage devices, flash memory devices, and other kinds of solid state memory devices, all a commonly used. The various applications that can implement the present invention run on electronic devices that may use at least one physical user interface or GUI device that provide the means of control and navigation within the operating system.

### Glossary of Terms

As used herein, a “computer system” or “system” or “computer assisted system” or “computer-implemented system” may refer to a networked system having one or more computers and/or other electronic devices, where each computer/electronic device may include computer-readable medium embodying software to operate the computer/electronic device or one or more of its components. Non-limiting examples of a computer system may include: a distributed computer system for processing information via computer systems linked by a network; and, two or more computer systems connected together via a network for transmitting and/or receiving information between the computer systems.

As used herein, the term “processor” may refer to any device or portion of a device or apparatus that processes electronic data from registers and/or memory to transform that electronic data into other electronic data that may be stored in registers and/or memory. A “computer system” may comprise one or more processors.

As used herein, the term “computer-readable medium” or “storage media” or “memory unit” or “non-transitory computer-readable media” refers to any medium that participates in providing data, for example, instructions, which may be read by a computer, an electronic device, a processor or a like device. Such a medium may take many forms, including but not limited to, non-volatile media, volatile media, and transmission media.

Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G etc.

As used herein, the term “Application” and/or “Software” refer to all, or a portion, of a computer program or software code that carries out a specific function and may be used alone or combined with other programs. It comprises computer program instructions adapted for execution by a hardware element, such as a processor, wherein the instruction comprise commands that when executed cause the processor to perform a corresponding set of commands. The software may be written or coded using a programming language, and stored using any type of non-transitory computer-readable media or machine-readable media well known in the art. Examples of software in the present disclosure comprise any software components, programs, applications, computer programs, application programs, system programs, machine programs, and operating system software.

Examples of software code in applications may include: code segments in one or more computer-readable languages; graphical and or/textual instructions; applets; pre-compiled code; interpreted code; compiled code; and computer programs. Computer program code for carrying out operations for aspects of the various embodiments may be written in any combination of one or more programming languages, such as: an object oriented programming languages and/or conventional procedural programming languages, and/or programming languages such as, for example, Hypertext Markup Language (HTML), Dynamic HTML, HTML5, Extensible Markup Language (XML), Extensible Style sheet Language (XSL), Document Style Semantics and Specification Language (DSSSL), Cascading Style Sheets (CSS), Synchronized Multimedia Integration Language (SMIL), Wireless Markup Language (WML), JAVA; JavaScript., JINI, C, C++, Objective C or any language operable on a wireless platform like iOS, Ruby, Ruby on Rails, Perl, UNIX Shell, Visual Basic or Visual Basic Script, Virtual Reality Markup Language (VRML), ColdFusion™; Adobe Flash & related languages; or other compilers, assemblers, interpreters or other computer languages or platforms.

As used herein, the term “Electronic Computing Device” or “Electronic Communication Device” or “Electronic Device” refers to device comprising at least one processor, a graphical interface user, such as a smartphone, laptop, desktop, tablet, wearable smart device, etc., as well as any device defined herein as a “computer” or “device”.

As used herein, the term “Graphical User Interface” or “Dynamic Graphical User Interface” refers to all the visually identifiable and/or intractable visuals displayed through a display of the electronic computing device.

A “client-side” application may refer to an application, a page associated with that application, or some other resource or function invoked by a client-side request to the application.

A “server-side” application may refer to an application running on the server in communication with the “Electronic Computing Device” or the “Electronic Communication Device” or the “Electronic Device” and is cable of exchanging, storing and processing data received from the client side application running on the “Electronic Computing Device” or the “Electronic Communication Device” or the “Electronic Device”.

As used herein, the term “network” or “communication networks” or “communication channel” or “wireless communication channel” may operate with any of a number of protocols, wireless, WiFi, and such as Internet protocol (IP), asynchronous transfer mode (ATM), and/or synchronous optical network (SONET), user datagram protocol (UDP), IEEE 802.x.

The following section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

The present invention relates to a computer assisted system and method for providing navigational assistance to a user towards a desired destination associated with a facility, according to a preferred embodiment of the present invention. The present computer assisted system and method for providing navigational assistance to the users collects one or more layout and other relevant information of the facilities, such as, but not limited to, buildings and other facilities, from authorized personnel associated with the facility and processes the information to present a real-time, dynamic, interactive navigational assistance information to a desired destination selected by the user. The present computer assisted system presents the real-time, dynamic, interactive navigational assistance information to the desired destination selected by the user based on a real-time location of the user. The real-time location of the user inside the facility is identified with high accuracy using one or more three-dimensional indoor positioning devices installed at different locations inside and exterior to the facility. Further, the present computer assisted system and method presents the real-time, dynamic, interactive navigational assistance information through an interactive dynamic graphical user interface of an application running on an electronic communication device of the users for easy navigation inside the facility. The present computer implemented system and method also provides navigational assistance towards the desired destinations interior to or exterior to the facility such as a building structure. According to one or more exemplarary embodiments, the present computer implemented system provides navigational assistance towards the desired destinations associated with the facilities such as, but not limited to, hospitals, universities, government departments, and other facilities selected from a group consisting of shopping malls, department stores, large outlets, conference places, trade shows, amusement parks, stadium complexes, schools, municipal buildings, museums, train stations, airports, busy down town centers, financial banking locations, parking facilities and any covered structure.

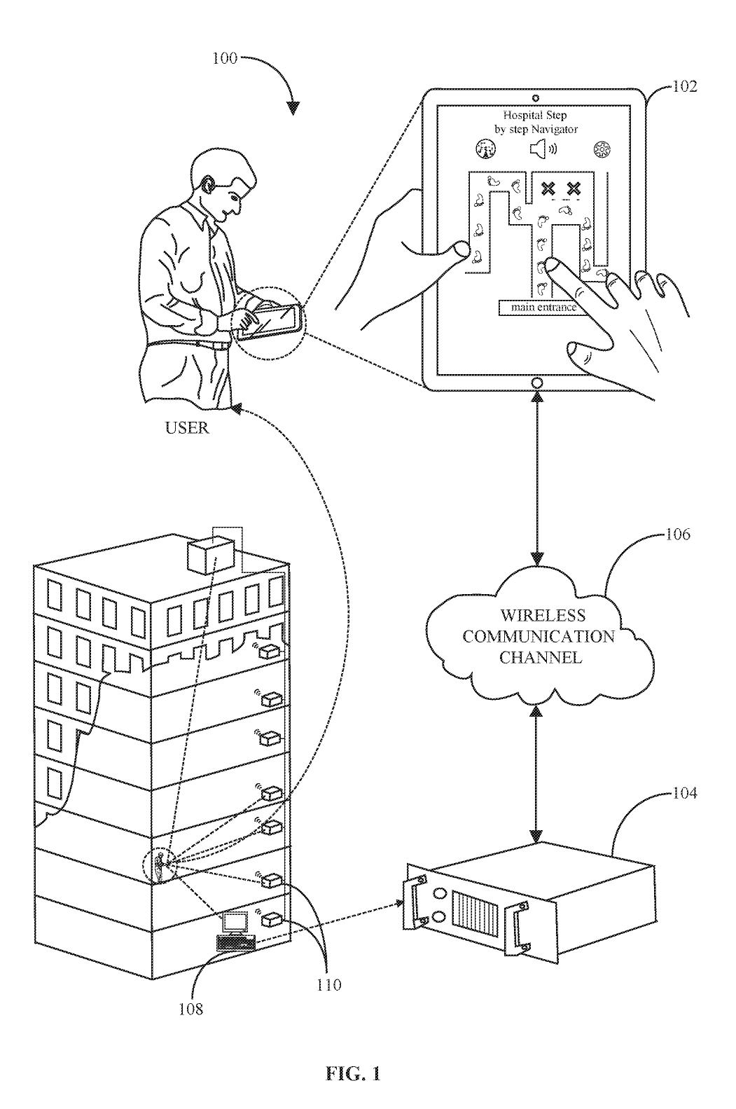

FIG. 1 is a schematic view of the present computer assisted system 100 for providing navigational assistance to the users towards the desired destinations associated with one or more facilities, according to a preferred embodiment of the present invention. In a preferred embodiment, the present computer assisted system 100 provides navigational assistance to the users towards any desired destinations inside the facilities such as any building structure. In some other embodiments, the present computer assisted system 100 provides navigational assistance towards the desired destinations inside or exterior to any facility such as the building structure. The present computer assisted system 100 for providing navigational assistance to the users towards the desired destinations, according to a preferred embodiment, includes an electronic communication device 102 having one or more processors configured to execute a number of instructions of an application retrievably stored in a memory unit in communication with the processor. These instructions when executed using the processor enables the electronic communication device 102 to provide a variety of services, such as, presenting a variety of indoor and outdoor location information associated with the facilities through an interactive dynamic graphical user interface of the application and providing a real-time, dynamic, interactive navigational assistance information to the desired destinations within or exterior to the facility, selected by the user, according to an embodiment of the present invention. The present computer implemented system 100 further includes a server 104 in communication with the electronic communication devices 102 for storing the indoor and outdoor location information associated with the facilities such as the landmarks, buildings and other public facilities. A wireless communication channel 106 enables communication between the electronic communication devices 102 and the servers 104 to provide the indoor and outdoor location information associated with the facilities and the real-time, dynamic, interactive navigational assistance information to the desired destinations selected by the users through the interactive dynamic graphical user interface of the application running on the electronic communication devices 102 of the users. The application running on the electronic communication devices 102 allow the users to navigate towards the desired destinations inside or exterior to the facility by following the real-time, dynamic, interactive navigational assistance information presented in form of a number of step-by-step visual and audible instructions presented through the interactive dynamic graphical user interface of the application.

The present computer implemented system 100 further includes one or more computer devices 108 associated with each of the facilities for providing the indoor and outdoor location information related to the facility to the server 104 over the wireless communication channel 106. In a preferred embodiment, the computer device 108 associated with each of the facilities allows the authorized users to upload a variety of facility related information such as, but not limited to, floor layouts information, amenities information, and a variety of other facility related information for easy navigation inside the facility. In some other embodiment, the computer devices 108 associated with each of the facilities includes wireless communication devices such as, but not limited to, Wi-Fi hotspot devices and other wireless communication devices that are configured to automatically connect with the electronic communication device 102 of the users for uploading the variety of indoor and outdoor location information related to the facility to the user's electronic communication device 102. In some instances, the application running on the electronic communication devices 102 of the users prompts the users to connect with the wireless communication devices in communication with the computer devices 108 of the facility as soon as the user enters or approaches the facility. Once the user agrees to the request, he/she is given access to the variety of indoor and outdoor location information related to the facility through the application running on the user's electronic communication device 102. In some other embodiment, the authorized users or personnel associated with the facility uploads the variety of facility related information such as, but not limited to, floor layouts information, amenities information, and a variety of other facility related information to the server 104 utilizing the computer devices 108 associated with each of the facilities. In some embodiment, the authorized personnel associated with the facility can utilize the computer devices 108 associated with the facilities to transfer the indoor and outdoor location information and guidance towards different destinations inside the facility or exterior to the facility to the server 104 over the wireless communication channel 106.

The server 104 receives the variety of indoor and outdoor location information related to the facility and processes and stores in a repository, which is then made available to the users through the application running on the electronic communication devices 102 of the users. In some instances, the users can request the variety of indoor and outdoor location information related to the facility from the server 104 through the application running on the electronic communication devices 102 of the users. In some other instances, the server 104 pushes the variety of indoor and outdoor location information related to the facility to the application running on the electronic communication devices 102 of the users over the wireless communication channel 106 when the user comes close to or enters the facility. In all the embodiments, the users can receive the variety of indoor and outdoor location information related to the facility through the application running on the electronic communication devices 102 of the users for easy navigation within the facility.

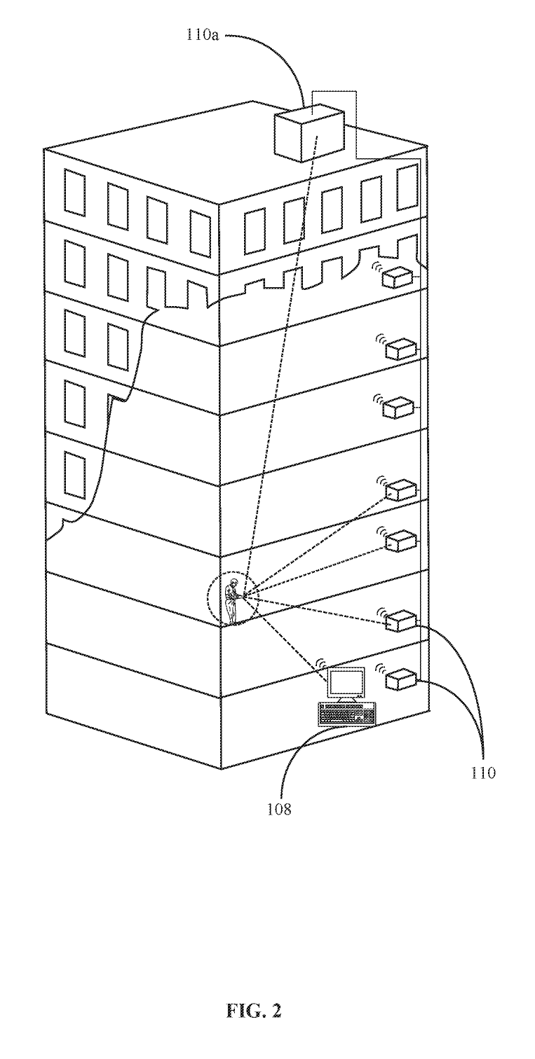

Before describing the invention in detail, the following paragraphs disclose the hardware components and devices utilized in the present computer assisted system 100 for achieving one or more features of the present invention. FIG. 2 illustrates the schematic diagram showing a number of three-dimensional indoor positioning devices 110 installed at a facility for identifying real-time locations of the electronic communication devices 102 of the users inside the facility, according to an embodiment of the present invention. The three-dimensional indoor positioning devices 110 installed at different locations inside or exterior to the facility is selected from a group consisting of direct current magnetic based 3D indoor localization devices, Wi-Fi based positioning devices, angle or arrival and time of arrival based positioning devices and signal strength based positioning devices, according to one or more embodiment of the present invention.

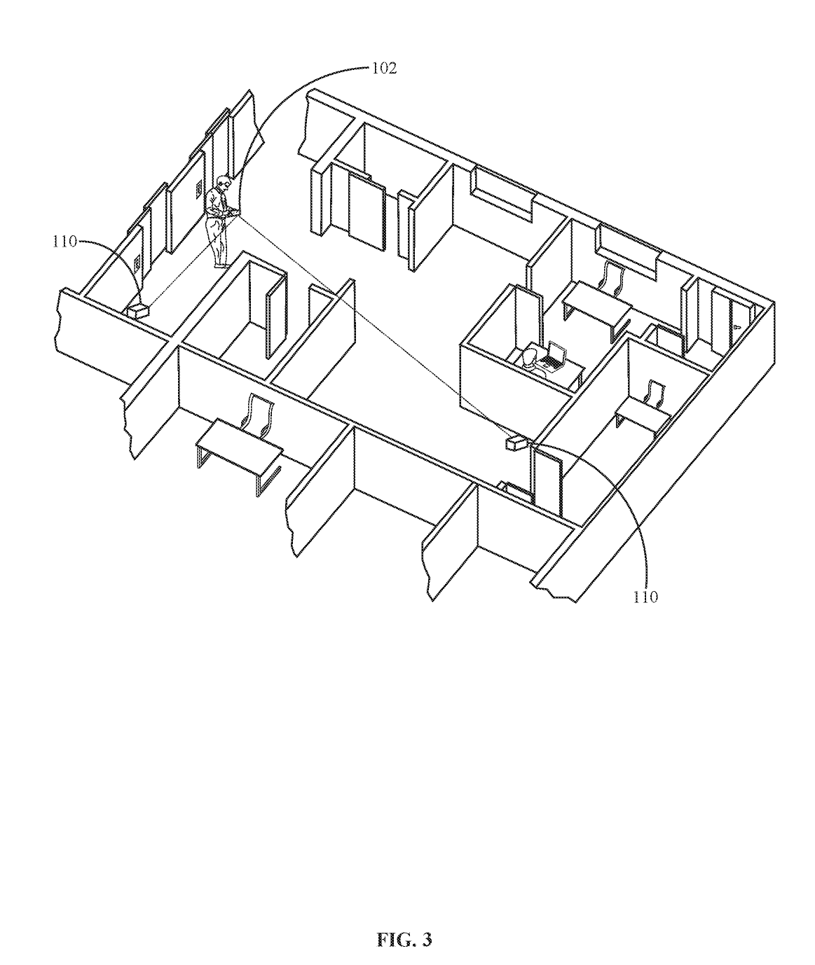

FIG. 3 illustrates the schematic diagram showing a number of three-dimensional indoor positioning devices 110 installed at a floor of a facility for providing navigational assistance to the users towards the desired destination in the floor, according to an embodiment of the present invention. In one embodiment, the three-dimensional indoor positioning devices 110 installed in a facility such as a hospital building or a shopping mall having multiple floors is a direct current magnetic based 3D indoor localization device 110. In some instances, the direct current magnetic based 3D indoor localization device 110 can locate the electronic communication devices 102 at any place inside the building with accuracy of one meter or less without using much additional wireless infrastructure for positioning. The direct current magnetic based 3D indoor localization device 110 can utilize the compass or sensors inside smartphones to sense the magnetic variations to map indoor locations of the user. In another embodiment, the three-dimensional indoor positioning devices 110 installed in the facility includes Wi-Fi based positioning devices, which are installed at each floor and at different locations. The location of the electronic communication devices 102 inside the facility is determined by analyzing the wireless connection strength between the electronic communication devices 102 and one or more of the Wi-Fi based positioning devices 110.

In a yet another embodiment, the three-dimensional indoor positioning devices 110 installed in the facility includes angle or arrival and time of arrival based positioning devices, which communicates with the electronic communication devices 102 to determine the exact position of the electronic communication devices 102 inside the facility based on the angle arrival or strength of the signal and time duration between the connections with the devices 110. In some instances, the three-dimensional indoor positioning devices 110 installed at the facility includes a central positioning device 110a in addition to the wireless positioning devices 110 installed at different floors of the facility. The central positioning device 110a and the wireless positioning devices 110 operates in tandem to determine the exact location of the electronic communication devices 102 inside the facility.

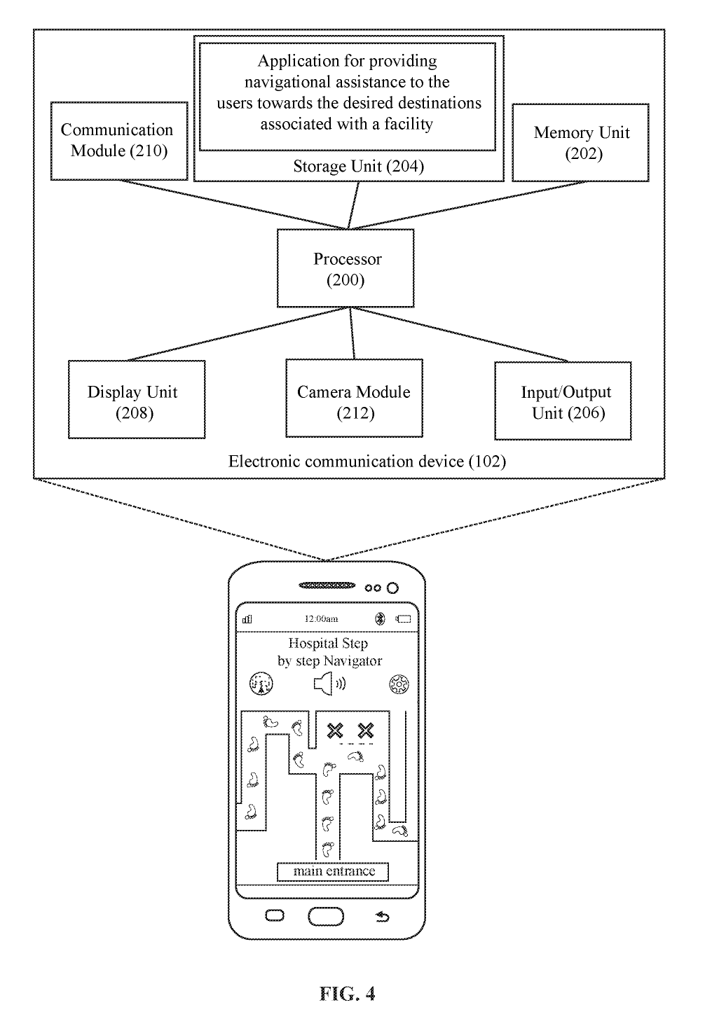

FIG. 4 illustrates the schematic diagram showing the hardware and software components of the electronic communication device 102, according to a preferred embodiment of the present invention. The electronic communication device 102 includes a processor 200, a memory unit 202, a storage unit 204, an input-output unit 206, a display unit 208, a communication module 210, a camera module 212 and other necessary components for providing the features of the present application for providing navigational assistance to the users towards the desired destinations associated with one or more facilities. The electronic communication devices 102 can be selected from a group consisting of smartphones, laptops, tablets, smart wearable devices, or any other electronic communication device having the above components and capable of running the application for providing navigational assistance to the users towards the desired destinations associated with the facility. The display units 208 used by the electronic communication device 102 may include LCD (liquid crystal display) technology, LED (light Emitting Diode) technology, CRT (Cathode ray tube) technology, or LPD (light emitting polymer) technology, or any other display technologies. Various realizations of graphics display circuitry that implement a Graphics Processing Unit (GPU) are used to achieve video interface between user and these electronic communication devices 102. Connectivity of these electronic communication devices 102 with the three-dimensional indoor positioning devices 110 installed at the facility and other networks, such as the internet, an intranet and/or wireless network, such as cellular telephone network, a wired or wireless local area network (LAN) and/or metropolitan area network (MAN) and/or WAN (wide area network) and other wireless communication is achieved by use of a variety of communication standards, protocols and technologies like Bluetooth, Wireless Fidelity (Wi-Fi) and/or any other suitable communication protocol, including communication protocols not yet developed as of the filing date of this document. Moreover, the present invention may be implemented on applications that run on a single or variety of operating system platforms, including but not limited to OS X, WINDOWS, UNIX, iOS, ANDROID, SYMBIAN, LINUX, or embedded operating systems. The present invention may also be implemented to work with various web browsers, including but not limited to, Internet Explorer, Mozilla Firefox, Safari, Opera, etc., that access and handle various types of web pages constructed with various mark-up languages, such as, but not limited to, HTML, HTML-5, XHTML, XML, etc. and the associated CSS (cascading style sheet) files and java-script files.

The users can access the application or download the application, which is available from an online application store such as, but not limited to, Google Play Store or App Store. The users are allowed to download the application and install in their electronic communication devices 102 such as smartphones prior to visiting the facilities, such as but not limited to, hospitals, universities, government departments, and other facilities selected from a group consisting of shopping malls, department stores, large outlets, conference places, trade shows, amusement parks, stadium complexes, schools, municipal buildings, museums, train stations, airports, busy down town centers, financial banking locations, parking facilities and any covered structure. In some instances, the server 104 in communication with the electronic communication device 102 of the users prompts the user to download the present application for providing navigational assistance to the users towards the desired destinations associated with the facility. In some other instances, the computer devices 108 associated with the facility or the wireless network available within or proximate to the facility, when recognized and connected using the electronic communication device 102 of the users, prompts the user to download the present application for providing navigational assistance to the users towards the desired destinations associated with the facility. In a yet another embodiment, as soon as the three-dimensional indoor positioning devices 110, such as Wi-Fi based positioning devices, installed at the facility recognizes the electronic communication device 102 of the users, prompts the user to download the present application for providing navigational assistance to the users towards the desired destinations associated with the facility.

The users can launch the application and register into the application by providing a variety of user information through a graphical user interface of the application displayed on the display unit 208 of the electronic communication device 102. The communication module 210 associated with the electronic communication device 102 enables the application to communicate with the server 104 over the wireless communication channel 106 established by the communication module 210. The wireless communication channel 106 can be selected from WLAN, mobile data communication or any other wireless communication method. The data provided by the users through the application are transferred to the server 104 through the wireless communication channel 106 established by the communication module 210. In some instances, the present application may include additional security modules in form of encryption to protect the data transferred between the server 106 and the electronic communication device 102. In addition, the electronic communication device 102 also includes additional modules for providing the location information using GPS module associated with the electronic communication device 102. Further, in some instance, the electronic communication device 102 also includes additional sensors and embedded modules for enabling communication with the three-dimensional indoor positioning devices 110 installed at different locations inside or exterior to the facility.

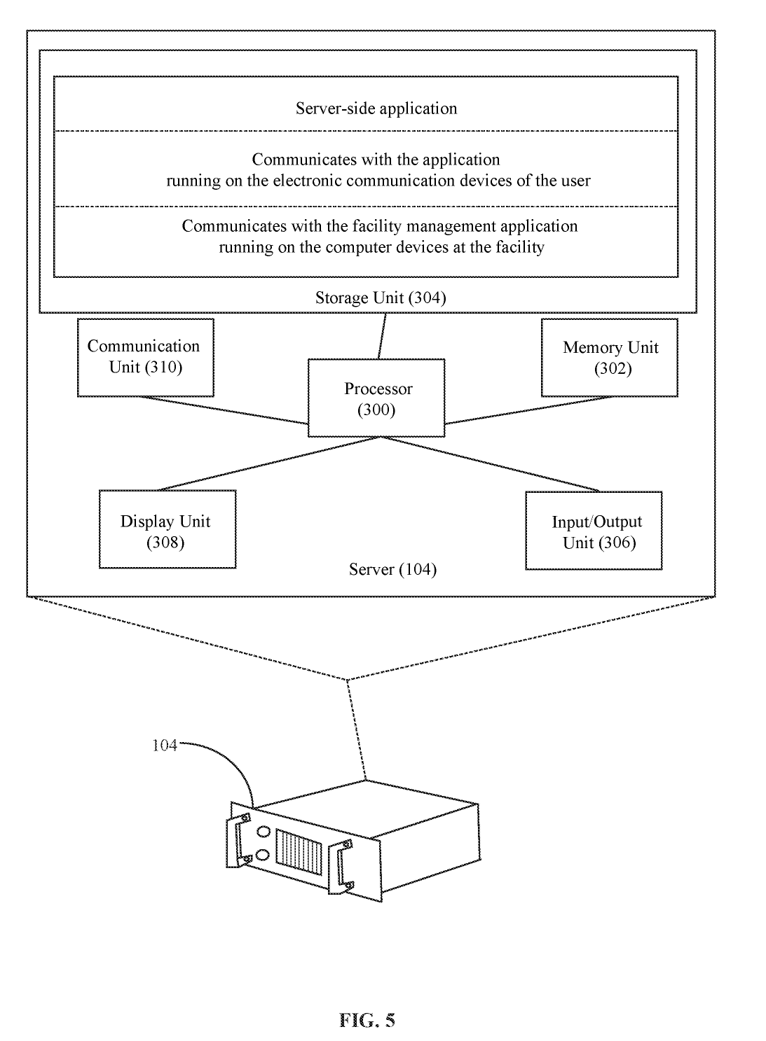

FIG. 5 illustrates a block diagram showing the different components of the server 104 in communication with the electronic communication device 102 running the application for providing navigational assistance to the users towards the desired destinations inside the facilities. The server 104 includes similar components as that of a computer such as a processor 300, a memory unit 302, a storage unit 304, an input-output unit 306, a display unit 308, a communication unit 310 and other necessary components for the proper and easy navigation within the facilities such as, but not limited to, hospitals, universities, government departments, and other facilities selected from a group consisting of shopping malls, department stores, large outlets, conference places, trade shows, amusement parks, stadium complexes, schools, municipal buildings, museums, train stations, airports, busy down town centers, financial banking locations, parking facilities and any covered structure. In a preferred embodiment, the storage unit 304 of the server 104 stores a server side application, which is complementary and designed to directly communicate with the application, for providing navigational assistance to the users towards the desired destinations inside the facilities, running on the electronic communication devices 102 of the user. The processor 300 executes a number of instructions of the server side application running on the server 106 and the communication module 310 communicates with the electronic communication devices 102 in real-time or easy navigation of the users inside the facility.

In some other instance, the server side application allow the authorized users to upload the indoor and outdoor location information associated with the facility through a web browser, a web application and/or an application interface for storage. The indoor and outdoor location information uploaded by the authorized users includes floor maps or blue prints of the facility, other facility related information and other relevant information for easy navigation inside the facility. In some other instances, the server side application allow the users of the electronic communication devices 102 to upload a variety of facility related information to the server 104 to form a crowd sourced data source for assisting easy navigation of other users inside the facility. In some instance, the users are allowed to upload the facility related information, such as, but not limited to, the most recent or real-time floor layouts information, amenities information, and other facility related information for easy navigation inside the facility, through the interactive dynamic graphical user interface of the application. Further in some other instances, the users can upload the facility related information such as crowd density inside the different floors or departments, availability of services at a particular floor, etc. through the dynamic graphical user interface of the application running on the electronic communication devices 102. The uploaded information is stored within the server 104 and made available to other users for easy navigation inside the particular facility. For example, the server side application running in the server 1104 retrieves the uploaded information such as crowd density at a particular department inside the facility or updated visitor timing at the particular department inside the facility for assisting or alerting other users of the present application inside that facility for easy navigation and better utilization of their time.

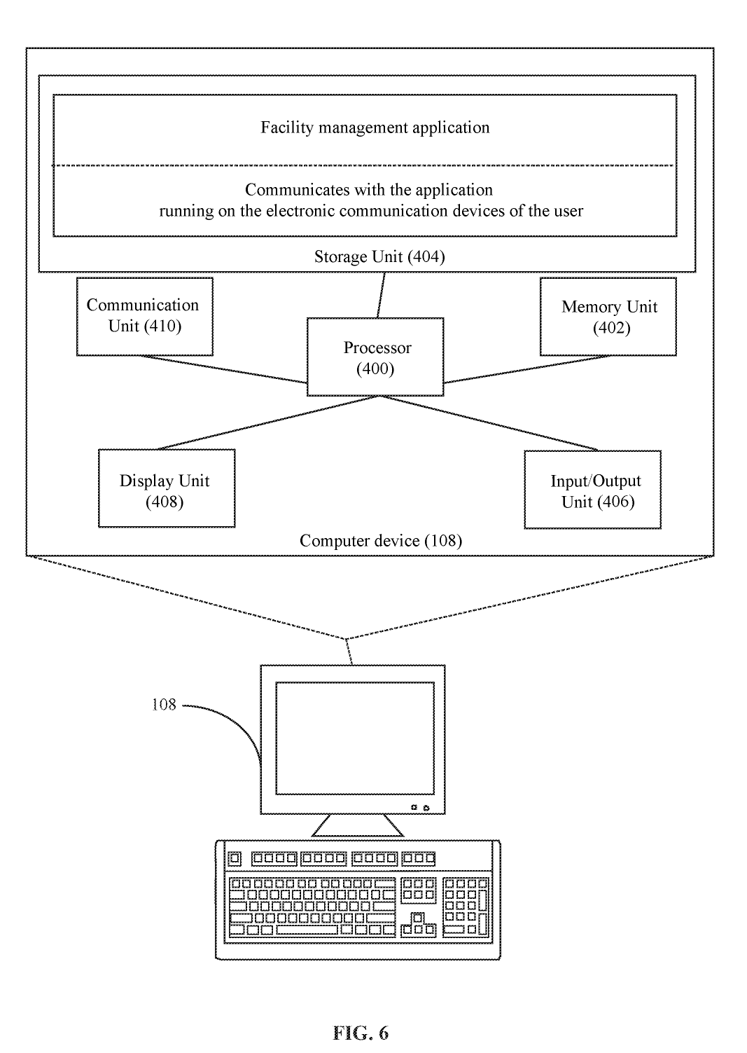

FIG. 6 illustrates a block diagram showing the different components of the computer devices 108 associated with the facilities, according to an embodiment of the present invention. The computer devices 108 includes similar components as that of a normal computer or a server such as a processor 400, a memory unit 402, a storage unit 404, an input-output unit 406, a display unit 408, a communication unit 410 and other necessary components for properly running a facility management application according to the embodiment of the present invention. In an exemplarary embodiment of the present invention, the facility management application is a hospital management application that allows the authorized personnel associated with the hospital facility to manage the patients, departments and other employees of the hospital facility. In some instances, the facility management application is a combination of one or more content management applications such as, but not limited to the, customer management application, internal management application and other facility related services management application. In some embodiments, the facility management application running on the computer devices 108 is configured to communicate with wireless hotspot devices installed at different locations within the facilities for connecting to the electronic communication devices 102 of the users via the wireless communication channel 106 such as Wi-Fi, or other wireless connectivity methods. In some instances, the application running on the electronic communication devices 102 of the users is configured to communicate with the facility management application running on the computer devices 108 of the facility, when the electronic communication devices 102 comes in proximity of the facility. The users can utilize the facility management application accessible through the application running on the electronic communication devices 102 of the users for a variety of tasks, such as, but not limited to, finding a location of a patient inside the hospital facility, finding location or floor of a specific department or personnel associated with the facility, etc. The collected information from the facility management application, accessed through the application running on the electronic communication devices 102 of the users, can further be utilized to obtain the real-time, dynamic, interactive navigational assistance information to the desired destination(s) inside the facility as selected by the user.

The present invention for providing navigational assistance to the users towards the desired destinations associated with a facility is described using various exemplarary embodiments hereinafter. According to a first exemplarary embodiment of the present invention, the present computer assisted system 100 is utilized for navigational assistance to the users towards the desired destinations inside and outside a hospital facility. The present computer implemented system 100 includes a server side application running on the server 104 and in communication with the application running on the electronic communication devices 102. The authorized users associated with the hospital facility can access the server side application from the computer device 108 at the hospital facility. The authorized users can utilize computer device 108 associated with the hospital facility to launch a web browser or web application or an Internet based application to upload the indoor and outdoor location information and navigation information inside the hospital facility to the server 104 over the wireless communication network 106. In some instance, the computer device 108 is associated with a number of personal hotspot devices installed within the hospital facility at different locations for providing Wi-Fi access to the users. When a user having the electronic communication devices 102 installed with the application enters the hospital facility, the personal hotspot devices installed at different locations within the hospital facility gets automatically connected to the application. The personal hotspot device transfers the indoor and outdoor location information and navigation information inside the hospital facility to the application running in the electronic communication devices 102 of the users. The application running in the electronic communication devices 102 processes the indoor and outdoor location information and navigation information received from the personal hotspot devices or the computer devices 108 and generates a dynamic, interactive navigational assistance map based information in real-time and presents the information through the interactive dynamic graphical user interface of the application. The real-time location of the user inside the hospital facility is obtained from the location of the respective personal hotspot devices currently being connected to the electronic communication devices 102 or from the three-dimensional indoor positioning devices installed at the facility or a combination of both or using the indoor GPS sensors of the electronic communication devices 102. In some other instances, the computer devices 108 associated with the hospital facility allows the authorized users to upload the indoor and outdoor location information and navigation information inside the hospital facility to the server 104.

The users of the electronic communication devices 102 running the application can download or access the indoor and outdoor location information and navigation information inside that particular hospital facility from the server 104 and can search a desired destination or department or location within the hospital facility through the interactive dynamic graphical user interface of the application. In some other instance, the application running on the electronic communication devices 102 receives the indoor and outdoor location information associated with the facility from the computer devices 108 and presents that information to the users through the interactive dynamic graphical user interface of the application. In some other instance, the indoor and outdoor location information is provided to the application in real-time based on the real-time location of the electronic communication devices 102 of the users identified using the three-dimensional indoor positioning devices 110 installed at the facility. The interactive dynamic graphical user interface of the application further presents the real-time dynamic, interactive navigational assistance map based navigation information for reaching the selected destination within the hospital facility. In some other instance, the application running on the electronic communication devices provides the real-time, dynamic, interactive navigational assistance information based on the real-time location of the electronic communication devices 102 identified by the three-dimensional indoor positioning devices 110 installed at the facility.

In some embodiment, the real-time, dynamic, interactive navigational assistance information associated with the facility includes a number of step-by-step instructions towards the desired destination provided through the interactive dynamic graphical user interface of the application. In a yet another embodiment, the interactive dynamic graphical user interface of the application provides the step-by-step instructions in form of augmented reality based real-time visuals and audio instructions towards the desired destination through the interactive dynamic graphical user interface of the application. For presenting the augmented reality based real-time visuals, the application utilizes the camera module 212 of the electronic communication devices 102 of the users to visualize the area surrounding the user, inside the facility, and the step-by-step instructions to the selected destination are provided as a transparent overlay over the camera visuals presented through the interactive dynamic graphical user interface of the application. The present application also allows disabled persons such as hearing impaired or visually challenging persons to easily navigate inside the facility towards the selected destination using the above audio and visual presentation feature. In some instance, the application running on the electronic communication devices 102 is configured to predict a distance and time taken to reach the selected destination inside the facility based on a number of factors including the real-time and past crowd sourced data retrieved from the server 104, real-time crowd density and service availability of the amenities inside the facility obtained from other users of the application present in the facility.

According to other exemplarary embodiment of the present invention, the present computer assisted system 100 is utilized for navigational assistance to the users towards the desired destinations inside and outside other facilities such as but not limited to, universities, government departments, shopping malls, department stores, large outlets, conference places, trade show buildings, amusement parks, stadium complexes, schools, municipal buildings, museums, train stations, airports, financial banking locations, parking facilities and any covered structure installed with the three-dimensional indoor positioning devices 110. In one or more embodiments of the present invention, the application running on the electronic communication devices 102 presents both outdoor navigation information, such as outdoor vehicle driving assistance information, and indoor navigation information associated with many of the above said facilities. In a yet another embodiment, the application running on the electronic communication devices 102 presents parking availability related information associated with the facilities and also provide navigation assistance to the selected available parking space inside the facility.

In one or more embodiments of the present invention, the interactive dynamic graphical user interface of the application running on the electronic communication devices 102 is configured to present the real-time location of the user with a real-time three-dimensional position awareness feature when compared to a size of the facility. This real-time three-dimensional position awareness feature accessible through the interactive dynamic graphical user interface of the application running on the electronic communication devices 102 is similar to a bird eye view of the user inside the facility. The real-time three-dimensional position awareness feature is presented with the help of real-time information collected from the three-dimensional indoor positioning devices 110 installed on the top floor or top of the facility and at other floors of the facility.

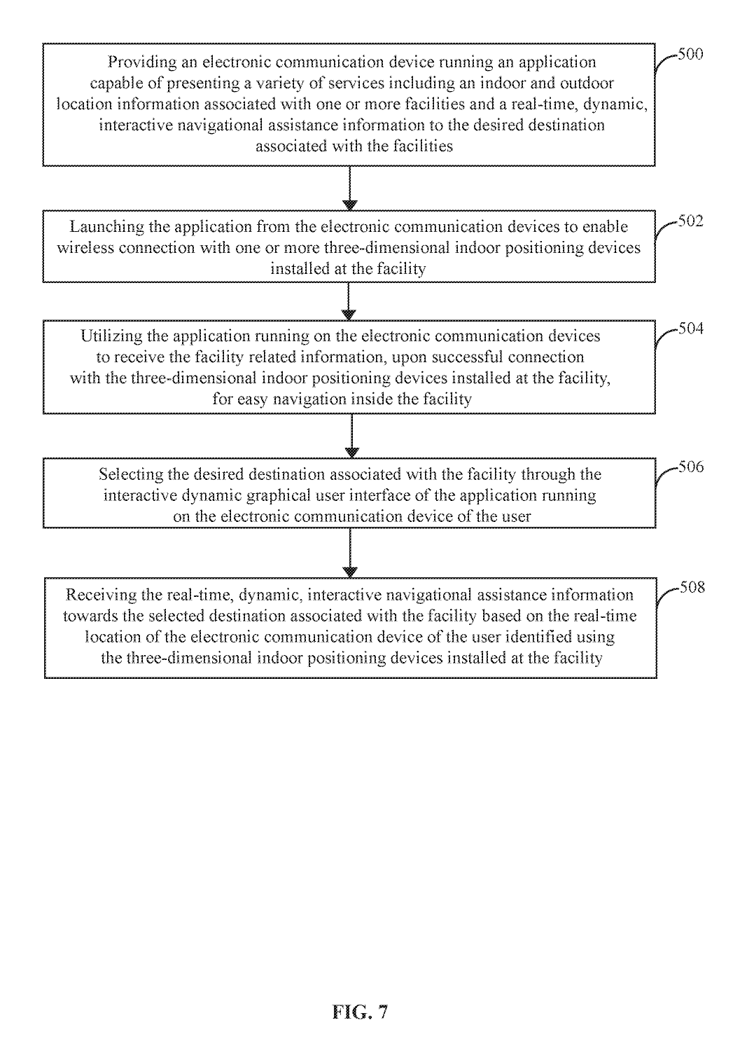

FIG. 7 is a flowchart showing a number of steps for receiving navigational assistance towards a desired destination associated with a facility, according to an embodiment of the present disclosure. The computer assisted method for providing navigational assistance to a user towards a desired destination associated with the facilities includes the steps of providing the electronic communication device 102 running the present application capable of presenting the variety of services including the indoor and outdoor location information associated with the facilities and the real-time, dynamic, interactive navigational assistance information to the desired destination associated with the facilities, as in block 500. The users, when inside or near the facility, can launch the application from the electronic communication device 102 to enable wireless connection with the three-dimensional indoor positioning devices 110 installed at the facility, as in block 502. Upon successful connection with the three-dimensional indoor positioning devices 110 installed at the facility, the application running on the electronic communication device 102 can be utilized to receive the facility related information for easy navigation inside the facility, as in block 504. The interactive dynamic graphical user interface of the application running on the electronic communication devices 102 allows the users to select the desired destination associated with the facility as in block 506. Now as in block 508, the users can receive the plurality of real-time, dynamic, interactive navigational assistance information towards the selected destination inside the facility based on the real-time location of the electronic communication devices 102 of the users identified using the three-dimensional indoor positioning devices 110 installed at the facility. The real-time, dynamic, interactive navigational assistance information received through the interactive dynamic graphical user interface of the application is in form of step-by step instructions to easily allow the users to navigate to the selected destination interior or exterior to the facility. In some instance, the application running on the electronic communication device 102 allow the users to communicate and collect information from the facility management application, such as the hospital management application or patient management application or a organization management application or a parking management application of the facility. The collected information from the facility related or facility management application can further be utilized by the application running on the electronic communication device 102 for easy navigation inside the facility.

In an exemplarary embodiment, information from the patient management application associated with a hospital facility can be accessed using the present application running on the electronic communication device 102. The users can utilize the present application to search for a patient using parameters such as date or admission, name, address, etc., and the data retrieved from the patient management application can be further utilized by the present application to receive the real-time, dynamic, interactive navigational assistance information towards the selected destination or the selected patient through the interactive dynamic graphical user interface of the application. In another exemplarary embodiment, information from the shopping facility management application associated with a shopping facility can be accessed using the present application running on the electronic communication device 102. The users can utilize the present application to search for a shop or service using parameters such as shop name, address, service type, etc., and the data retrieved from the shopping facility management application can be further utilized by the present application to receive the real-time, dynamic, interactive navigational assistance information towards the selected destination or the selected shop or service through the interactive dynamic graphical user interface of the application. In another exemplarary embodiment, information from the organization management application associated with a large organization can be accessed using the present application running on the electronic communication device 102. The users can utilize the present application to search for a department or service within the organization using parameters such as department name, service type, etc., and the data retrieved from the organization management application can be further utilized by the present application to receive the real-time, dynamic, interactive navigational assistance information towards the selected destination or the selected department or service through the interactive dynamic graphical user interface of the application.

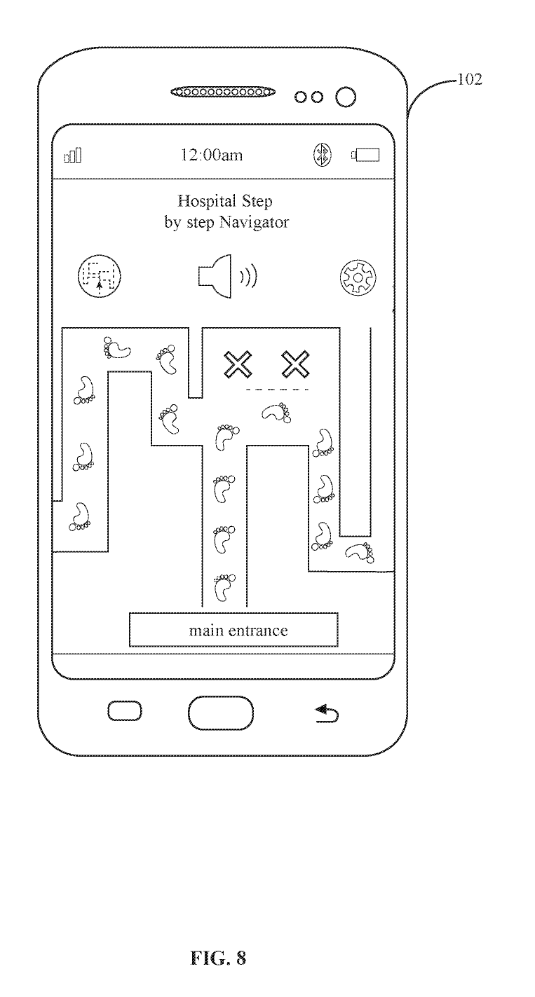

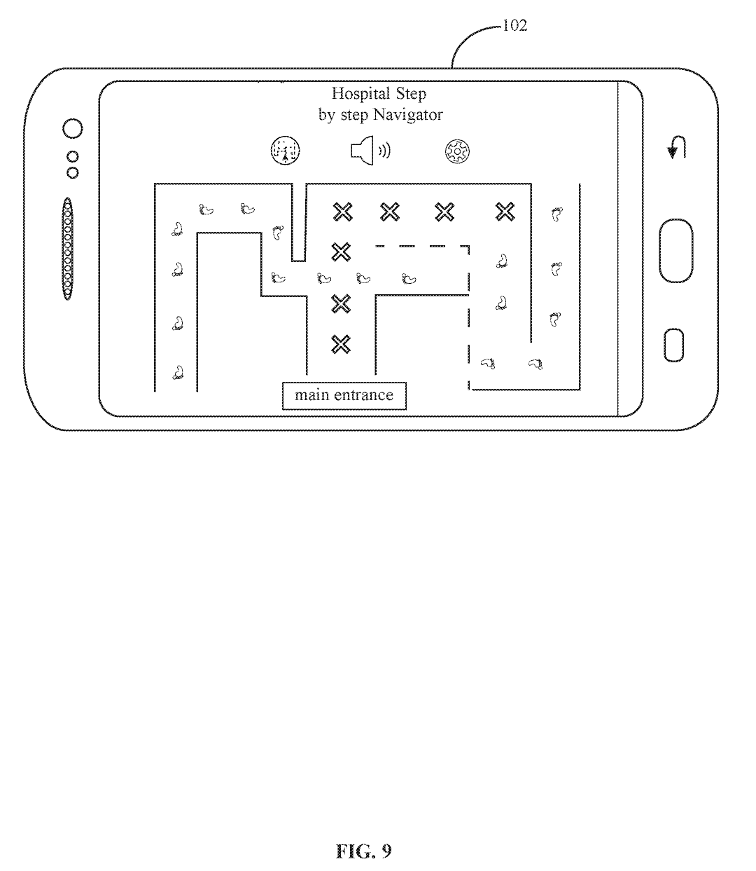

In some embodiment, the real-time, dynamic, interactive navigational assistance information towards the selected destination presented through the interactive dynamic graphical user interface of the application running on the electronic communication device 102 of the users includes step-by-step instructions in form of augmented reality based real-time visuals and audio instructions towards the selected destination. FIG. 8 and FIG. 9 shows the augmented reality based user interfaces of the application running on the electronic communication devices 102 of the user for providing navigational assistance to the users towards the desired destination associated with a facility, according to one or more embodiments of the present disclosure. Upon selecting the desired destination inside the facility through the interactive dynamic graphical user interface of the application running on the electronic communication device 102, the application generates the step-by-step instructions in form of augmented reality based real-time visuals and audio instructions towards the selected destination utilizing the floor plan or floor map of the facility. The application generates the step-by-step instructions in form of augmented reality based real-time visuals as an overlay over the camera feed of the electronic communication device 102. The floor plan or floor map of the facility presented in the augmented reality based real-time visuals includes other information such as entry and exit information, amenities information such as stairs, escalators, restroom facilities etc. The step-by-step instructions provides visual and audible instructions based on the real-time location of the electronic communication device 102 of the user identified using the three-dimensional indoor positioning devices installed at the floor. The augmented reality based real-time visuals automatically updates as the user moves within the facility following the step-by-step instructions presented through the interactive dynamic graphical user interface of the application. Any wrong movement by the user, triggers a visual or audible alert or both or a tactic feedback such as a vibration of the electronic communication device 102. In some instance, the interactive dynamic graphical user interface of the application also presents an expected time and overall route map for reaching the selected destination inside the facility. Further, the user can interact with the interactive dynamic graphical user interface of the application to receive any other relevant information such as the floor layouts information, amenities information, and other facility related information for easy navigation inside the facility.

Further, it should be noted that the steps described in the method of use can be carried out in many different orders according to user preference. The use of “step of” should not be interpreted as “step for”, in the claims herein and is not intended to invoke the provisions of 35 U.S.C. § 112, (6). Upon reading this specification, it should be appreciated that, under appropriate circumstances, considering such issues as design preference, user preferences, marketing preferences, cost, devices requirements, available services, technological advances, etc., other methods of use arrangements such as, for example, different indoor location detection methods within above-mentioned list, elimination or addition of certain steps, including or excluding certain maintenance steps, etc., may be sufficient.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. A computer assisted system for providing navigational assistance to a user towards a desired destination associated with a facility comprising:
a) an electronic communication device having at least one processor configured to execute a plurality of instructions of an application for providing a plurality of services including:
i. a plurality of indoor and outdoor location information associated with the facility; and
ii. a real-time, dynamic, interactive navigational assistance information to the desired destination;
b) a plurality of three-dimensional indoor positioning devices, capable of communicating with the electronic communication devices, installed at a plurality of locations associated with the facility for identifying a real-time location of the electronic communication devices;
c) at least one server in communication with the electronic communication devices for storing the indoor and outdoor location information associated with the facility; and
d) at least one wireless communication channel to enable communication between the electronic communication devices and the servers to provide the plurality of real-time, dynamic, interactive navigational assistance information to the desired destinations selected by the users;
whereby the application running on the electronic communication devices allow the users to navigate towards the desired destination interior or exterior to the facility by following the plurality of real-time, dynamic, interactive navigational assistance information presented through an interactive dynamic graphical user interface of the application.

2. The computer assisted system of claim 1, wherein the electronic communication device includes at least one sensor to communicate with the plurality of three-dimensional indoor positioning devices installed at the facility to obtain the real-time, dynamic, interactive navigational assistance information to the desired destination selected by the user,
wherein the desired destination selected from the interactive dynamic graphical user interface of the application is interior or exterior to the facility.

3. The computer assisted system of claim 1, wherein the plurality of three-dimensional indoor positioning devices is selected from a group consisting of a plurality of direct current magnetic based 3D indoor localization devices, Wi-Fi-based positioning devices, angle or arrival and time of arrival based positioning devices and signal strength based positioning devices.

4. The computer assisted system of claim 1, wherein the server runs a server side application to allow a plurality of authorized users to upload the plurality of indoor and outdoor location information associated with the facility through a web browser, a web application and/or an application interface, and
wherein the plurality of indoor and outdoor location information includes at least one floor map of the facility, a plurality of facility related information and other relevant information for easy navigation inside the facility.

5. The computer assisted system of claim 1, wherein the application running on the electronic communication devices is configured to allow a plurality of users to download the plurality of indoor and outdoor location information associated with the facility through the interactive dynamic graphical user interface of the application, and
wherein the server side application communicates with the application running on the electronic communication devices over the wireless communication channel to transfer the plurality of indoor and outdoor location information for easy navigation inside the facility.

6. The computer assisted system of claim 1, wherein the application running on the electronic communication devices is configured to allow the plurality of users to upload a plurality of facility related information to the server to form a crowd sourced data source for assisting easy navigation of the plurality of users inside the facility.

7. The computer assisted system of claim 6, wherein the plurality of facility related information uploaded through the interactive dynamic graphical user interface of the application includes a plurality of floor layouts information, amenities information, and a plurality of other facility related information for easy navigation inside the facility.

8. The computer assisted system of claim 1, wherein the application running on the electronic communication devices provides the plurality of indoor and outdoor location information associated with the facility to the users through the interactive dynamic graphical user interface of the application, and
wherein the plurality of indoor and outdoor location information is provided based on the real-time location of the electronic communication devices of the users identified using the plurality of three-dimensional indoor positioning devices installed at the facility.

9. The computer assisted system of claim 1, wherein the application running on the electronic communication devices provides the plurality of real-time, dynamic, interactive navigational assistance information based on the real-time location of the electronic communication devices identified by the plurality of three-dimensional indoor positioning devices installed at the facility.

10. The computer assisted system of claim 9, wherein the plurality of real-time, dynamic, interactive navigational assistance information associated with the facility includes a plurality of step-by-step instructions towards the desired destination provided through the interactive dynamic graphical user interface of the application.

11. The computer assisted system of claim 10, wherein the interactive dynamic graphical user interface of the application provides the plurality of step-by-step instructions in form of a plurality of augmented reality based real-time visuals and audio instructions towards the desired destination.

12. The computer assisted system of claim 1, wherein the application is configured to predict a distance and time to reach the desired destination of the user based on a plurality of factors including crowd density and service availability of a plurality of amenities inside the facility.

13. The computer assisted system of claim 1, wherein the interactive dynamic graphical user interface of the application includes a real-time three-dimensional position awareness feature to present the real-time location of the user compared to a size of the facility.

14. The computer assisted system of claim 1, wherein the facility is selected from a group consisting of hospitals, universities, government departments, shopping malls, department stores, large outlets, conference places, trade show buildings, amusement parks, stadium complexes, schools, municipal buildings, museums, train stations, airports, financial banking locations, parking facilities and any covered structure installed with the plurality of three-dimensional indoor positioning devices.

15. The computer assisted system of claim 1, wherein the application running on the electronic communication devices is configured to allow the plurality of users to interact with at least one facility management application associated with the plurality of facilities to enable the users to receive a plurality of relevant information for easy navigation inside the facility.

16. A computer assisted method for providing navigational assistance to a user towards a desired destination associated with a plurality of facilities comprising the steps of:
a) providing an electronic communication device running an application for presenting a plurality of services including:
i. a plurality of indoor and outdoor location information associated with the plurality of facilities; and
ii. a real-time, dynamic, interactive navigational assistance information to the desired destination associated with the plurality of facilities;
b) launching the application from the electronic communication device to enable connection with a plurality of three-dimensional indoor positioning devices installed at the facility;
c) receiving a plurality of facility related information through the application for easy navigation inside the facility;
d) selecting the desired destination associated with the facility from the interactive dynamic graphical user interface of the application running on the electronic communication device; and
e) receiving the plurality of real-time, dynamic, interactive navigational assistance information towards the desired destination based on a real-time location of the electronic communication devices identified by the plurality of three-dimensional indoor positioning devices installed at the facility;
whereby the real-time, dynamic, interactive navigational assistance information received through the interactive dynamic graphical user interface of the application allows the users to easily navigate to the desired destination interior or exterior to the facility.

17. The computer assisted method of claim 16, wherein the plurality of real-time, dynamic, interactive navigational assistance information towards the desired destination presented through the interactive dynamic graphical user interface of the application includes a plurality of step-by-step instructions in form of a plurality of augmented reality based real-time visuals and audio instructions towards the desired destination.

18. The computer assisted method of claim 16, wherein the application running on the plurality of electronic communication devices allows the users to interact with at least one facility management application associated with the facilities to receive a plurality of relevant information for easy navigation towards the desired destination inside the facility.

19. The computer assisted method of claim 16, wherein the plurality of facility related information received through the application includes a plurality of floor layouts information, amenities information, and a plurality of other facility related information for easy navigation inside the facility.

20. An electronic communication device for providing a plurality of real-time, dynamic, interactive navigational assistance information towards a desired destination associated with a facility comprises:
a) at least one processor configured to execute a plurality of instructions of an application, retrievably stored in a memory unit in communication with the processor, for providing a plurality of services including:
i. a plurality of indoor and outdoor location information associated with the facility; and
ii. a real-time, dynamic, interactive navigational assistance information to the desired destination associated with the facility;
b) a wireless communication unit to communicate with at least one server over a wireless communication channel for receiving the plurality of indoor and outdoor location information for easy navigation inside the facility;
c) at least one sensor for communicating with a plurality of three-dimensional indoor positioning devices installed at the facility to identify a real-time location of the electronic communication device;
d) a display unit configured to display an interactive dynamic graphical user interface of the application for visually presenting the plurality of real-time, dynamic, interactive navigational assistance information towards the desired destinations selected by the users,
wherein the plurality of real-time, dynamic, interactive navigational assistance information is continuously updated, in real-time, based on the real-time location of the electronic communication device; and
e) an audio unit for audible presentation of the real-time, dynamic, interactive navigational assistance information to the desired destinations selected by the users;
whereby the interactive dynamic graphical user interface of the application displayed on the display unit allows the users to interact with the plurality of indoor and outdoor location information and the plurality of real-time, dynamic, interactive navigational assistance information for easy navigation inside the facility.
